(19) United States
(12) Patent Application Publication
(10) Pub. No.: US 2023/0117441 A1
(43) Pub. Date: Apr. 20, 2023

(54) METHOD AND SYSTEM FOR ENABLING MULTI-LEVEL REAL-TIME COLLBORATION IN GAME ENGINES SUPPORTING HETEROGENEOUS PROJECT STATES

(71) Applicant: KinematicSoup Technologies Inc., Kelowna (CA)

(72) Inventors: Justin MCMICHAEL, Kelowna (CA); Alyosha PUSHAK, Kelowna (CA); Yipin GUO, Kelowna (CA); Gregory HOVDE, Kelowna (CA)

(21) Appl. No.: 17/914,609

(22) PCT Filed: Mar. 29, 2021
(86) PCT No.: PCT/CA2021/050412

§ 371 Date: Sep. 26, 2022

Related U.S. Application Data
(60) Provisional application No. 63/000,519, filed on Mar. 27, 2020.

(51) Int. Cl. A63F 13/63; A63F 13/73

(52) U.S. Cl. CPC A63F 13/63; A63F 13/73

(57) ABSTRACT

A system and method of enabling improved collaboration between developers in a game development environment, the system and method including an authoritative hierarchy host (AHH) that monitors and maintains a hierarchy of objects. The AHH communicates with users that are developing in the game development environment to handle conflicts so that collaboration between the different users is improved.

### CROSS-REFERENCE TO OTHER APPLICATIONS

The current disclosure claims the benefit of priority from U.S. Provisional Application No. 63/000,519 filed Mar. 27, 2020, which is hereby incorporated by reference.

### SUMMARY

The disclosure is generally directed at computer technology, and more specifically, at a method and system for enabling multi-level real-time collaboration in game engines supporting heterogeneous project states.

### BACKGROUND

The tools used to create video games have evolved significantly over the last two decades. Development focuses around an editor tool, which provides a real-time perspective on the game, or programming, environment being created, as well as a method of managing assets within the game environment, which include geometry, textures, shaders, images, sounds, and code elements. Users of the editor tool create the game environment in a visual way where ‘what you see is what you get’.

Game engines, or authoring environments, provide a tool, or editor environment, where users can assemble audio/visual assets together with game, or programming, code to create an interactive experience. Part of the game engine editor is a scene view, which allows game developers and designers to place the assets into a scene.

As content has gotten richer and environments more complex, the need for collaboration has necessarily increased. Currently visual editor tools are limited to a single user working in a game environment at a time which limits the rate at which work can be performed.

Multiple solutions have been attempted to solve this problem. One method allows multiple people to edit a game environment at one time and enabling them to witness each other's changes in real-time or near real-time. Another current solution is to subdivide the game, or programming, environment into sub-sections where each sub-section is modified by a different user, or developer, concurrently.

Therefore, there is provided a novel method and system for enabling multi-level real-time collaboration in game engines supporting heterogeneous project states.

### SUMMARY

The disclosure is directed at a method and system to enable real-time collaboration for modern real-time engines.

The disclosure provides a method and system that enables real-time collaboration that is more effective than current systems and provides additional functionality that improves workflow visibility, and is extensible.

In one aspect of the disclosure, there is provided a system for enabling multi-level collaboration in a game development environment including one or more Authoritative Hierarchy Hosts (AHH) for storing a hierarchy of objects that are used in the game development environment; and a plurality of clients, in communication with the one or more AHH, for hosting authoring environments for editing the game development environment; wherein the plurality of clients communicate with the one or more AHH to update the hierarchy of objects during development.

In another aspect, the one or more AHH include a network layer for communicate with each of the plurality of clients; and a data interpretation layer for processing messages from the plurality of clients. In a further aspect, the one or more AHH maintains the hierarchy of objects to resolve conflicts between the plurality of clients. In yet another aspect, each of the plurality of clients includes a local AHH hierarchy of objects cache for storing a local version of the hierarchy of objects; and an authoring environment control plugin (AECP) for enabling communication between the client and the one or more AHH. In an aspect, each of the plurality of clients includes an authorizing environment for editing the game development environment.

In another aspect of the disclosure, there is provided a method of enabling multi-level collaboration in a game development environment including generating a hierarchy of objects associated with the game development environment within an authoritative hierarchy host; and managing the hierarchy of objects via communications with a plurality of clients, each of the plurality of clients programming in the game development environment.

In a further aspect, managing the hierarchy of objects includes receiving an update from one of the plurality of clients with respect to one of the objects in the hierarchy of objects; and transmitting a message to each of the other of the plurality of clients to update a local hierarchy of objects with respect to the one of the objects in the hierarchy of objects. In yet a further aspect, managing the hierarchy of objects includes resolving conflicts associated with use of objects between the plurality of clients. In yet another aspect, resolving conflicts associated with use of objects is based on an objects lock methodology. In yet a further aspect, resolving conflicts associated with use of objects is based on a revisions number methodology.

### BRIEF DESCRIPTION OF THE DRAWINGS

Embodiments of the present disclosure will now be described, by way of example only, with reference to the attached Figures.

FIG. 1 is a schematic diagram of a system for enabling multi-level real-time collaboration in game engines supporting heterogeneous project states;

FIG. 2 is a schematic diagram of an authoritative hierarchy host (AHH);

FIG. 3 is a flowchart outlining a method of generating an initial local hierarchy;

FIG. 4 is a flowchart outlining a method of generating a subsequent local hierarchy;

FIG. 5 is a flowchart outlining a method of comparing objects between a subsequent local hierarchy and the object hierarchy in the AHH;

FIG. 6 is a set of example screenshots;

FIG. 7 is a schematic diagram of an object lock scenario;

FIGS. 8a to 8i are schematic diagrams showing a revision number conflict resolution methodology;

FIG. 9 is an example of a stand-in asset; and

FIG. 10 is an example of terrain data.

### DETAILED DESCRIPTION

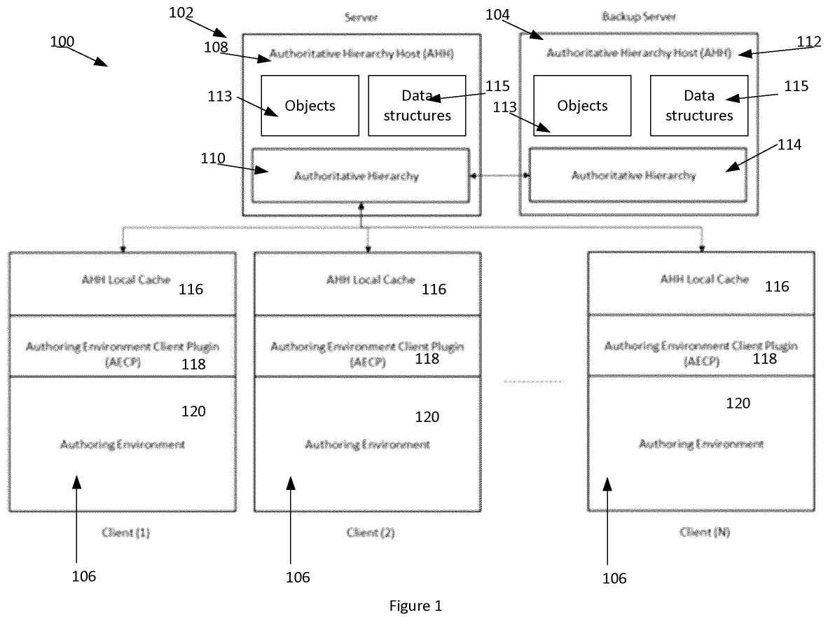

Turning to FIG. 1, a schematic diagram of a system to enable real-time collaboration for real-time server engines is shown. The system 100 includes a server 102 that is connected to a backup server 104. The server 102 is also connected to, or in communication with, a set of clients 106. It is understood that Client(N) represents an unknown number of clients and does not mean that there are only 14 clients. In the current embodiment, the backup server 104 acts as a redundant server and stores the same information as the server 102 and operates in the same manner as the server 102. In other embodiments, there may not be a need for a backup sever.

The clients 106 may represent individual users, or developers, who are working on a game, or gaming, environment in collaboration with each other.

Within the server 102 is a server authoritative hierarchy host 108 (AHH) that includes a server authoritative hierarchy interface (AHI) 110. The backup server 104 includes a backup server AHH 112 and a backup server AHI 114. Both AHI interfaces 110 and 114 enable its respective server 102 or 104 to communicate with the individual clients 106. In the following description, reference is made to communication with only the server 102, however, it is understood that any interactions between client 106 and the server 102 will also apply to client 106 and the backup server 104.

As shown in FIG. 1, the server AHI 110 and the backup server AHI 114 also communicate with each other.

In general, each AHH 108 or 112 includes a hierarchy of objects 113 and their associated data 115. The objects 113 may be seen as generic containers that can be parented to create hierarchical structures whereby each object contains a property or set of properties. In one embodiment, the backup server 104 may store AHH instances that are mirror copies of the AHH instances in the server for redundancy, or they may each contain unique subdivision of the AHH to provide higher performance.

Each client 106 includes an AHH local cache 116, an authoring environment client plugin (AECP) 118 and an authoring environment 120. The authoring environment 120 may be seen as an editing tool which each user or developer may use to develop the game environment. It is understood that the server 102, backup server 104 and the clients 106 may include other components, however, only those components that are relevant to the current disclosure are shown.

Typically, each client, or client server, which may also be seen as a workstation contains a copy of an environment software or programming, game or project environment that includes game project files that is editable by the developer via the authoring environment 120. As understood, in the world of software development, the game project files may change on one client during development but not on the other client or clients. This means that setting up the AHH should be tolerant of these differences. In one embodiment, the AHH may be used to handle conflicts between clients when they are editing the same asset so that changes are properly stored within the game environment. One advantage of the current disclosure is that the system may provide a more collaborative development environment for multiple clients (or developers) working on the same game environment.

In operation, the authoring environments are used by users to interact with a virtual space (seen as the game environment). The authoring environments may also vary from client to client. Each authoring environment interacts with the AHH 108 using the AECP 118 associated with that client 106. In the following description, while AHH 108 is referred to as the AHH that communicates with the client 106, it is understood that the same operations and interactions may follow with respect to the backup server AHH 112, however for simplicity and clarity reasons, the disclosure only refers to interaction with the AHH 108. In one embodiment, each AECP 118 may contain a local cache for AHH data to reduce network overhead and latency, reconcile project state differences between clients, and/or to maintain a consistent state between the authoring environment 120 and the AHH 108.

In some embodiments, applications (located on clients) connect to the AHH 108 via network connections. When connected, a copy of the AHH may reside or be stored on the client as a separate process, on a remote host (not shown), or a combination of the two.

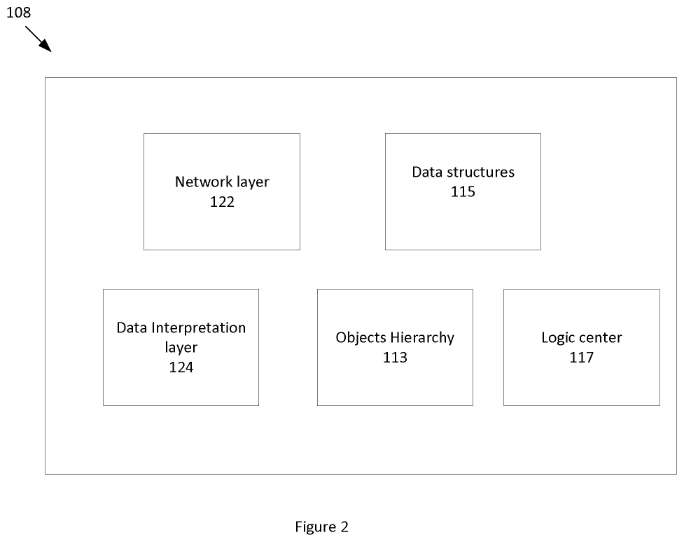

Turning to FIG. 2, a schematic diagram of an AHH is shown. The AHH of FIG. 2 may be seen as either the server AHH 108 or the backup server AHH 112. In the current embodiment, the AHH, or server includes the objects hierarchy 113, the data structures 115, a logic center 117, a network layer 122 and a data interpretation layer 124. The network layer 122 enables the AHH 108 to communicate with the AECP of each of the clients and the data interpretation layer 124 parses messages that are received from the clients. These messages may include commands and data relating to edits being made to the game environment.

In one embodiment, the network layer 122 may be implemented via code such as a node.js or a custom sockets implementation. More broadly, the network layer 122 may be seen as a layer that supports the sending and receiving of messages from clients simultaneously. In one embodiment, the network layer sends and receives serialized messages containing requests to store or change data.

While shown as being located within a server in FIG. 1, the AHH may also be located on a computer that includes a central processing unit (CPU), random access memory (RAM) and a non-volatile memory system such as, but not limited to, a solid-state drive. In one embodiment, the network layer uses a reliable communication protocol for communication with clients such that the reliable protocol guarantees that the clients always receive data from the AHH and vice-versa. Different protocols include, but are not limited to, Hypertext Transfer Protocol (HTTP), WebScockets, Secure Hypertext Transfer Protocol (HTTPS), Secure Websockets (WSS), or any other request/response-based or bidirectional stream-based protocol such as TCP, or a variant of UDP that provides reliability. The communication protocol encapsulates messages that contain data to be parsed. The protocol does not need to provide any other function than to route messages via the network from the AHH to the client. The network layer extracts the message from the protocol and provides it to upstream processing at the data processing layer.

The message format can be XML, JSON, or any manner of text or binary message. The data processing layer raises Hierarchy Change Events based on requests received from clients. These events are used by the AHH logic center 117 to determine if the in-memory data hierarchy should be modified. Should such a modification occur, the AHH logic center serializes the hierarchy change which is then relayed to all connected clients.

In one embodiment, and as will be described below, when the AHH receives a message, data interpretation layer parses the message for the commands and data and then modifies the objects hierarchy 113 accordingly. In some scenarios, conflicts may arise when the AHH receives multiples messages from clients associated with the same object/data being modified. The AHH will then determine how to handle these conflicts to enable a more collaborative development experience.

As many current game engine authoring tools (seen as the authoring environments 120) use a local hierarchy as an authoritative default, the system of the disclosure includes a modification to the authoring environment 120, which may be implemented via a plugin, extension or module, that subjugates the local hierarchy to the AHH 108. This plugin may be seen as the AECP 118.

When an environment (or workspace), such as the game environment, is loaded onto the client 106, the AECP 118 connects to the AHH 108 and provides credentials to the server 102 in order for the client 106 to be authorized and allowed access to the server 102. If authorized, the client 106 is granted access to the data within the AHH 108. The AHH data may then be stored locally on the client, such as in the AHH local cache 116.

If the game environment that is loaded onto the client 106 is not already present on the AHH 108, the client, or client server (or user via the client) uses AHH data structures to build a full description, or replica, of the game environment directly upon the AHH 108. Subsequent access of this game environment by other clients that connect to the AHH verify any local data they have for the game environment and merge any changes that have been recorded on the AHH 108.

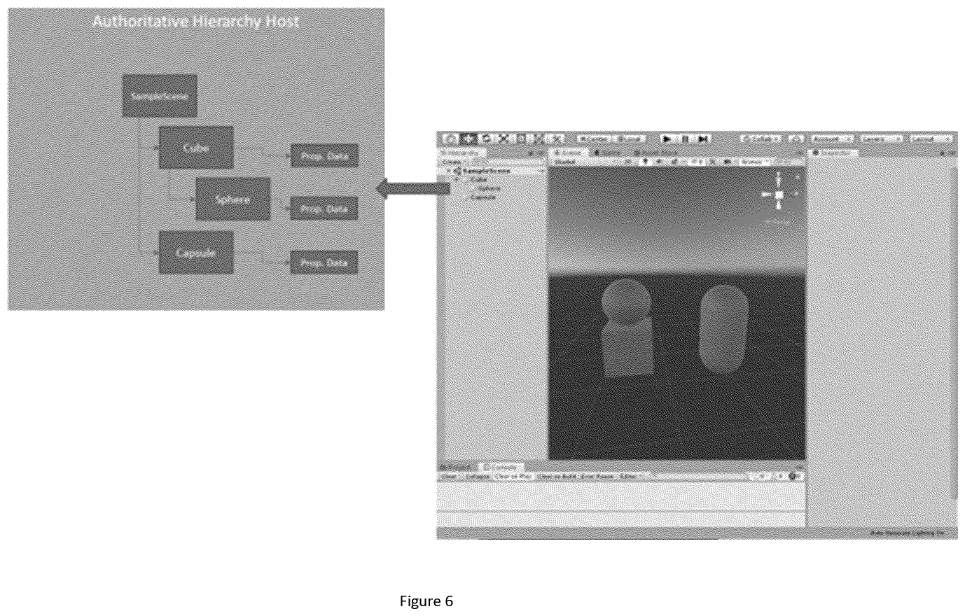

In one embodiment, the AHH 108 uses two data structures, an object type and a property type. An object type may be seen as a container that contains both objects as children and properties. In one embodiment, each object has an identification (ID), a type string, a property which may be a collection of properties, and an ordered list of children. Properties contain values and their associated type information such as 8-bit integer (or byte), 16-bit integer, 32-bit integer, 64-bit integer, 32-bit floating point, UTF-8 string, dictionary, reference to other object or property, and array of any of these types. This is schematically shown in FIG. 6.

As discussed above, there is a need to implement a tolerance in both the server AHH and/or the backup server AHH to address situations where there is a conflict between two clients with different project, or game, environments.

To implement this tolerance, it is assumed that a first developer to set up the game environment in the AHH 108 possesses a desired project state on their client 106, and other workstations, or clients, possess projects that are either in the same desired state or in an updated state.

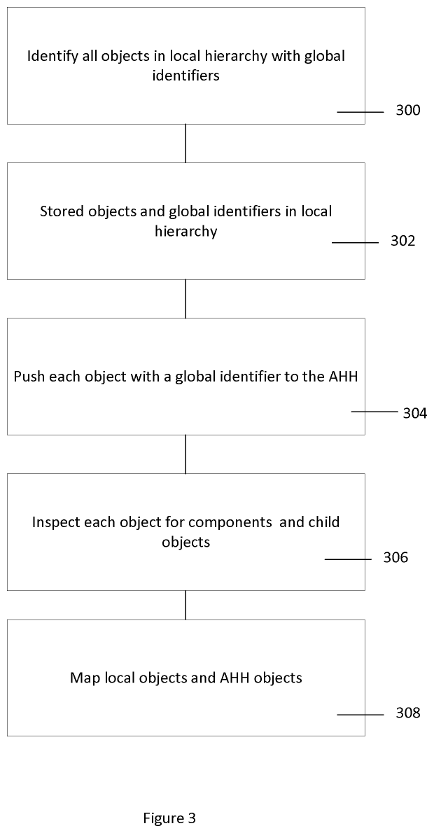

In one embodiment, a process for the first user who starts or creates and uploads the initial game environment from their client to the AHH is schematically shown in FIG. 3. Initially, all objects in the local hierarchy (within the client) are identified with Global Identifiers (GIDs) such that each object must have or be given a persistent identifier with a global scope (300). In one embodiment of this identification, the AECP of the client traverses every object in its hierarchy. If the objects do not have a GID, the AECP assigns one to the object. Some objects may be ignored because they are identified as non-syncable. Objects that are hidden or transient (not saved in the game environment permanently) are non-syncable, unless explicitly made syncable via an application programming interface (API) call. The API allows individual objects or object types to be marked as non-syncable. Typically, non-syncable objects do not get GIDs. Also, GID generation, if required, may use a subset of data from the object and any attached children or components to generate the ID deterministically. The subset of data used to determine the ID number varies depending on factors such as, but not limited to, the game engine, object name, object type, object components and types, and values of object or component properties. These GID associations with objects may then be stored (302) either as an external mapping or as components on the objects themselves within the local hierarchy. It is understood that GIDs do not change once they have been generated. If is further understood that new objects created during a programming, or development, session are assigned GIDs that are generated to be unique and are not generated using the deterministic hash.

After identifying the objects, each object is, pushed, or recorded to the AHH by the client (304). The client then inspects each object in the local hierarchy for components and child objects (306). Any discovered components are recorded to the AHH as child objects of the object recorded previously, but is also assigned a property called “type” that identifies them as components, not objects. Thus, an object in the AHH without a type property is considered an object, whereas an object with a type property is considered a component. If the components are determined to be non-syncable, these may be ignored. A mapping between local objects and AHH objects is then created or generated (308) whereby visible component properties and their data may be recorded in the AHH and attached to their representative objects. In one embodiment, the client maintains a mapping of the local objects in the local game environment within the authoring environment and their representation within the AHH.

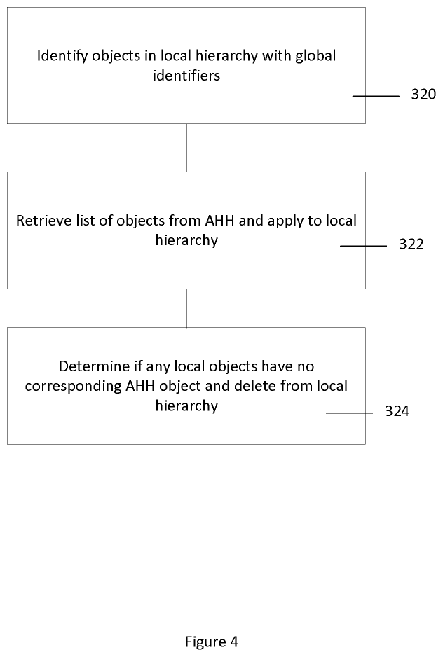

When a subsequent user access the programming, or game, environment, the system may perform the method outlined in the flowchart of FIG. 4. Initially, the subsequent client identifies the objects in its local hierarchy with GIDs (320). This part of the process may be seen as the same or similar to (300) of FIG. 3.

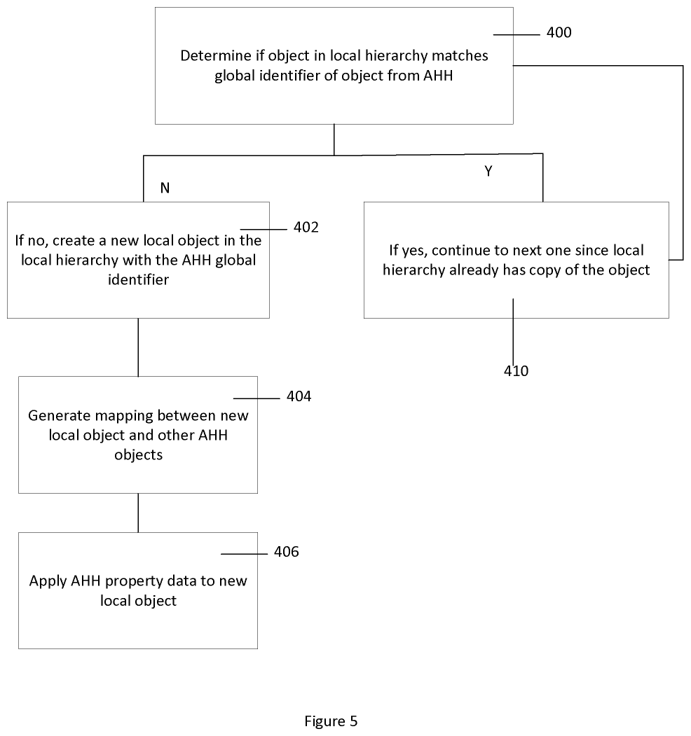

After the identification, each object from the AHH 108 is retrieved from the AHH and then applied to the local hierarchy of the subsequent client (322). One method of performing this is schematically shown in FIG. 5.

Initially, a search is performed to determine if there is an object in the local hierarchy with a GID matching an AHH object's GID (400). If no local object with a matching GID is found, a new local object is created (402) and a mapping between local objects and any new AHH objects is created (404). Property data from the AHH is then retrieved from the server and applied to the local object and all components/sub-objects (408). For objects that already exist and are in an identical state to their AHH counterparts, no syncing is required and the system continues to check the next object (410). Also, local components/sub-objects that have no corresponding AHH object are deleted locally, unless those objects are marked as non-syncable.

Turning back to FIG. 4, after going through the list of objects in the AHH, if it is\ determined that there are local objects that do not have a corresponding AHH object, these local objects are deleted locally off the subsequent client (324). Each AECP monitors its local game environment for changes performed by the user, or by code running within the game environment. These changes may be detected using authoring environment features or functionality, such as, but not limited to, events or notifications, and active monitoring.

If the authoring environment provides events that cover all modifications performed to the local hierarchy, and all objects, components, and properties contained therein, the AECP will capture these events in order to detect changes made to objects. For events that are not provided, the AECP will monitor for changes by comparing object state that has no change events with the AHH state to find changes.

In one embodiment, when an event describing exactly what has been changed on the client is not available, certain protocols may be followed. These protocols may include but are not limited to, If an event is available that describes what object(s) changed but not what specifically changed, object(s) can be scanned for changes when that event fires or occurs.

If an event is available that indicates something has changed but provides no more details, all objects in the game environment may be placed in a list when that event fires or occurs. The objects in the list may then be scanned for changes. In one embodiment, this scanning activity may be provided a limited time per frame to avoid slowing down the authoring environment. Once a high or maximum amount of processing or scanning time is exceeded in a frame, the AECP stops scanning for changes until the next frame, even it if is midway through scanning an object. Once an object is scanned, it is removed from the list. On the next frame, the AECP may resume scanning objects where it left off. The high or maximum time may be a fixed time or dynamic based on how much processing time has already occurred in the current frame. Because objects that are selected are more likely to have changes, objects in the list are prioritized by how recently they were selected to increase the likelihood changes are detected sooner.
If there is no way to tell when a state may have changed, the AECP may regularly monitor for changes, limiting how much time is spent in a single frame to avoid slowing down the authoring environment.

If any changes are identified, the AHH then transmits these changes to the all of the clients working in the game environment in real-time so that their game environment is updated with the latest status. In some embodiments, the AHH will buffer and store larger data types, such as mesh, terrain, texture, mask data, or UV data, for efficient delivery. This buffer also allows new clients to join and receive the updates for these large data types.

When a user (via the authoring environment of the client) manipulates the local object hierarchy of the local game environment, the call is intercepted by the AECP and transmitted or communicated to the AHH. In response, the AHH invokes logic to determine if the action (or change) is allowed based on permissions and/or the results of conflict resolution logic. The result or determination is then transmitted to all connected clients such that their AECP can update the local AHH cache or local version of their hierarchy.

Users can manipulate the local hierarchy, and thereby the AHH 108, in different manners. In one embodiment, the AHH may be manipulated or changed by creating objects where one or more objects can be created as a single request. The objects may be created as root objects or as children of an existing object and may have child objects. In another embodiment, the AHH may be manipulated by deleting an object whereby when an object is deleted, its children are also deleted. In another embodiment, the AHH may be manipulated by locking an object to prevent other users from or reduce the likelihood of other users editing an object's properties or the properties of its descendants (children) and/or ancestors (parent). This may also prevent other users from or reduce the likelihood of other users attaching, detaching, or rearranging the children of an object or its descendants. Another way to manipulate the AHH is for the user (or client) to release a lock on an object, allowing other users to edit it again. In one embodiment, only the original user who locked the object can unlock the object. In other words, during development, a client may lock an object within the AHH hierarchy such that any updates to that object from other clients is not allowed. The AHH may also be manipulated by detaching an object from its parent, making it a root object. Another method of manipulation may be to attach an object to a parent at a specified child index. If the object already has a parent, it will be detached from its current parent. Another way in which the user may manipulate the AHH is to move a child to a different index in its parent's child list. Also, the AHH may be manipulated by setting a property or sub-property (field of a dictionary or element of a list), removing a field from a dictionary property, inserting elements into a list property and/or removing elements from a list property.

After a manipulation of the hierarchy has been completed, the AHH transmits signals to the clients involved with the programming, or game, environment relating to the manipulation or changes to the hierarchy. The clients then perform functions allowing the client to respond to and apply changes to the data within the game environment. These changes may be from other users or may be to revert local changes that were denied because of locks.

In response to these changes the events, or functionality, that the client may fire, or perform, include, but are not limited to, an on create functionality which may be called when an object is created whereby if the object has children, this is called only for the root object or if the object was created as a child of an already existing object, its child index is provided as a parameter; an on delete functionality which may be called when an object is deleted such that when an object is deleted, its children are also deleted, but the event only fires for the root object and an on confirm delete functionality that may be called when a deletion request sent by the client is confirmed. Other events or functionality may include an on-lock functionality that is called when an object becomes locked by another user or an on unlock functionality that is called when an object locked by another user becomes unlocked. Further functionality may include an on lock owner change functionality that is called when an already locked object changes lock ownership or an on direct lock change functionality that is called when an object's direct lock ownership changes (where the direct lock owner is the user who acquired the lock on the object but this differs from an indirect lock owner, where the user acquires a lock on an ancestor) and unlike other lock events, this one is raised when the local user owns the lock. Yet further functionality may include an on-parent change functionality that is called when an object is attached to a new parent, detached from its parent to become a root object, or moved within its parent's child list, giving it a new child index whereby if the object is not a root object, its child index is provided as a parameter. For instance, if the child at index 5 is moved to index 2, that increases the index of the objects that used to be at indices 2-4, but the parent change event will only be called on the child that caused the index changes, which in this case is the child moved from 5 to 2. Yet further functionality may include an on property change functionality that is called when a property (or sub-property) of an object changes, however, removing fields from dictionaries or inserting/removing elements from lists have their own events and may not execute this functionality. Other functionality may include an on dictionary remove functionality that is called when a field is removed from a dictionary; an on list add functionality that is called when one or more elements are inserted in a list; and/or an on list remove functionality that is called when one or more elements are removed from a list. One other functionality may include an on acknowledge subscription functionality that is called when the server (or AHH) acknowledges a client has subscribed or unsubscribed from an object.

In some embodiments, game environments may be divided into sub-scenes or sub-environments that can be loaded and edited independently. In order to mimic this on the AHH, local scene data such as via the game environment is loaded onto the client. For each scene that is loaded, a scene root object is added to the AHH. Properties are set with the information about the sub-scene, such as originating file and engine-specific scene properties. The objects and data from the sub-scene are attached to this scene root.

The system allows two different workflows for working with multiple scenes. In a first workflow, all users (or clients) must have the same scenes, or sub-scenes, loaded onto their client. When another client connects to the server AHH using the first workflow, all scenes that are on the server are loaded locally onto all the participating clients and their hierarchies are reconciled with the server AHH as described previously. Any scenes that a client had loaded that does not include the AHH scene objects are unloaded.

When any user loads a new scene additively, a scene root object is created and populated with child objects as described previously and added to the AHH. All other clients will load the same scene. When any user unloads a scene, the AHH scene root object is deleted, and all clients unload the scene.

The second workflow allows clients to load and work on different sub-scenes simultaneously. When a subsequent client connects to the AHH, the subsequent client does not load the child objects of the scene root objects from the server initially. All other clients will check the AHH for scene roots that correspond for any scenes they have loaded and for any scene roots that are found, each client will request the child objects and apply them to the local hierarchy. If there is no corresponding AHH scene root object, that client will create one and populate it with child objects. Other clients will receive an event, or message, informing them of the newly created scene root object but will not see the children unless they request it when loading that scene.

When any user loads a scene additively using the second workflow, if there is already a scene root object for the scene in the AHH, the client associated with that user will request child objects for that scene and apply them. If there is no AHH scene root object, they will create one.

When any user unloads a scene using the second workflow, the scene root is kept in the AHH and they stop receiving updates to the children of the scene root.

Typically, a project, which refers to all files used to create a game, may change state on any of the clients during the development phase. In one embodiment, the project includes the game environment as well as other asset files. These other asset files may include graphics, audio, code, configuration and object templates that amalgamate the assets into prefabs, blueprints or templates that may be used in the game environment. The game environment has access to or references these prefabs, which may be modified by developers, thereby changing the components and/or properties that the prefabs contain or associated with. Because these changes do not get replicated on all clients simultaneously, there is a need to handle these updates.

The change in state often happens when one user (or client) is making changes to some element of the project to advance its development. This means that these project differences must be detected and handled gracefully, without interrupting real-time replication on the other clients.

In operation, each AECP monitors the local state of the hierarchy on its associated client. The methods it uses vary depending on the integration environment. Some methods of monitoring of assessment are outlined below.

Consider the case where user 1 and user 2 have two different versions of component X: client 1 has properties A and B, and client 2 has properties A and C.
1) Client 1 adds an X component to an object.
   a) Client 1 creates an AHH object for X with properties “A” and “B” and uploads it to the AHH.
2) Client 2 gets the AHH object for X
   a) Client 2 creates an X component.
   b) Client 2 applies the property value for A from the AHH object to X
   c) Client 2 ignores property “B” because their version of X has no B property.
   d) Client 2 keeps C at its default value because the AHH object has no “C” property.

In some cases, with multiple clients editing the same game environments, there may be a need to handle conflicts that arise when multiple users, or clients, try to edit the same thing at the same time. The system and method of the disclosure applies two strategies. Both strategies rely on a granular object-level locking mechanism and grouping updates into discrete ‘frames’.

A first strategy, or methodology, is the employ object locking. The second strategy, or methodology, is to use revision numbers.

As background, to explain the two methodologies, there is a need to understand the use of frames. A frame is generated by the server (or AHH) and includes a sequence of instructions for each client to execute to stay in sync with the server and an incrementing frame number. These frames are sent at regular or irregular intervals to all connected clients. A frame is created once the server has resolved the actions submitted from multiple clients within a given time window. In one embodiment, the time window may be 100 milliseconds. Clients connected to the server send data containing requests to change the state of the AHH. The server collects these requests within the time window and evaluates the requests to generate a new state for the given time window which is returned to all clients.

Alternatively, a server may respond to each client on-demand, and process state information from the clients when state changes are requested. In this example, there is no discrete time window, and the server responds to every request sent by client directly.

For the first methodology, object locking may be seen as a mechanism to simplify conflict resolution. When a client selects an object that is not already locked by another user or client, the client sends a lock request to the server (or AHH) for that object. If the client selects a locked object, the client will send a lock request if the object is still selected when it becomes unlocked.

When the server receives the lock request, the server grants the lock request as long as no other new lock requests were received before the current client request and if the object is not already locked. When the lock is granted, the server notifies all other clients to lock the object to prevent or reduce the likelihood the locked object being edited by another client and notifies the client that requested the lock that the lock is granted and editing by the client can proceed.

With respect to locks, there are two kinds of object locks: fully locked objects and partially locked objects. Partially locked objects may be seen as objects that cannot be deleted or have their properties edited while fully locked objects cannot be deleted, cannot have their properties edited and cannot have their children edited. When a user or client locks an object, it becomes fully locked and the lock cascades downwards, fully locking all descendants (children) of the object. All the ancestors (parents) become partially locked. In other words, the object the user requested a lock on is directly locked while the descendants and ancestors are indirectly locked.

Furthermore, a fully locked object is always locked by one client, and only that client can edit the fully locked object while a partially locked object may be locked by multiple clients if different descendants of that object are locked by different clients. If only one client is partially locking an object, that client can choose to edit it or to fully lock it.

In order to monitor the frames, each object on the server (or sored in the AHH) stores the frame number at which it last became fully locked and/or the frame number at which it last became fully or partially locked.

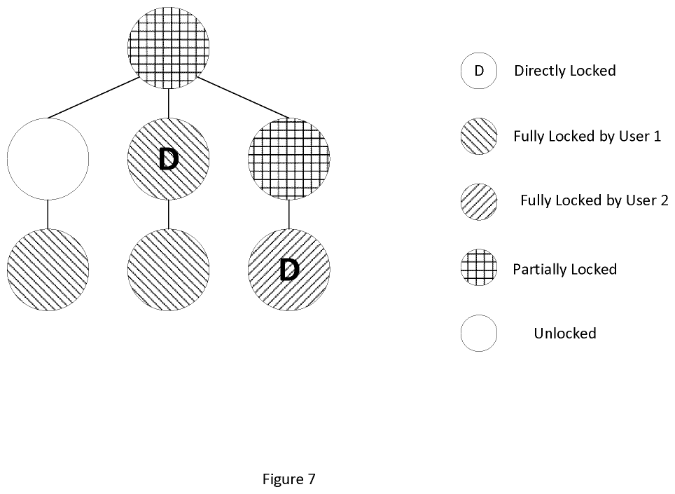

All requests from clients to modify an object in the AHH, including to lock an object, include the frame number for the last server frame the client has processed. If the object is locked by another client, or the frame number at which it last became locked is greater than the frame number sent with the request, the request is denied. For requests to add, remove, or re-order children, the frame number in the request is only checked against the frame number the object last became fully locked. This is schematically shown in FIG. 7.

Any requests to modify the object hierarchy (such as deleting objects, re-ordering, attaching, or detaching children) require the objects being modified to be locked by the user or client making the request. If the user sends a request to modify the hierarchy without first locking the object, if the request is allowed (whereby the objects subject the modification are not locked by other users), the user who sent the request is granted a temporary lock that is removed once the requested change is applied.

The second methodology may be seen as a revision number methodology. In a typical programming environment, properties may be edited without locking an object, in which case multiple users may be editing properties on the same object at the same time. In order to perform conflict resolution, the second methodology may be used where the clients and server (or AHH) maintain a revision number for each property.

On the server or AHH, the revision numbers may be seen as server frame numbers corresponding to the server frame at which the value was set or updated. When making a request to modify an object or to change the AHH hierarchy, clients include the last server frame they received in change requests that were transmitted to the AHH. When the server, or AHH, gets a request from a client to set a property, if any ancestor property has a revision number higher than the server frame number sent in the request, the server ignores the request.

For clients, the revision numbers are per-object numbers, starting at 1 and auto-incremented each time the client changes a value on an object they do not own a direct lock on. They are sent to the server (AHH) as part of the property change request. The AHH acknowledges the property change by sending the revision number back. If the server tells a client to change a property that has an unacknowledged revision number, the client will ignore the property change since it knows it has a more up-to-date value.

Any property on the client with a revision number equal to or less than the last one acknowledged by the server gets acknowledged by the server. In contrast, revision numbers are not set when objects are locked, because only the client who owns the lock can modify properties, so there will be no conflicts to resolve.

Operations that modify a property but do not recreate the property, such as adding or removing dictionary fields or resizing an array, do not set the revision number. Eg. Setting a field on a dictionary will set the revision number for the field, but not for the dictionary. Setting a property to an entirely new dictionary will set the revision number for the dictionary.

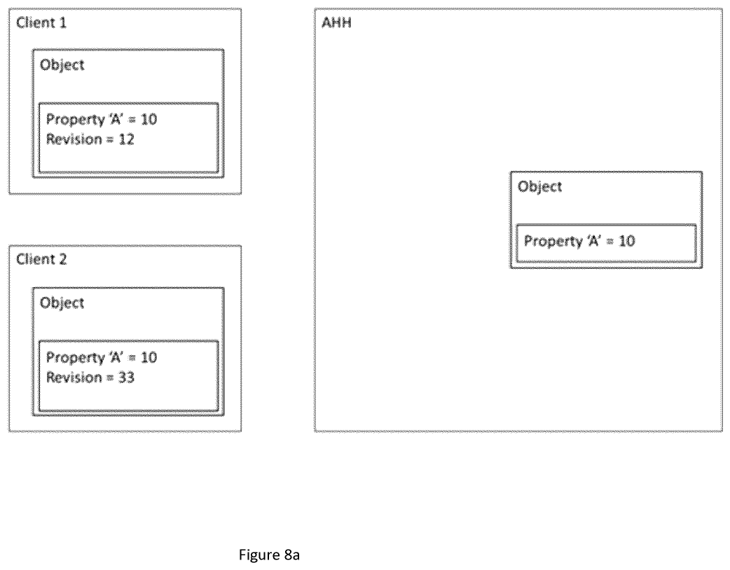

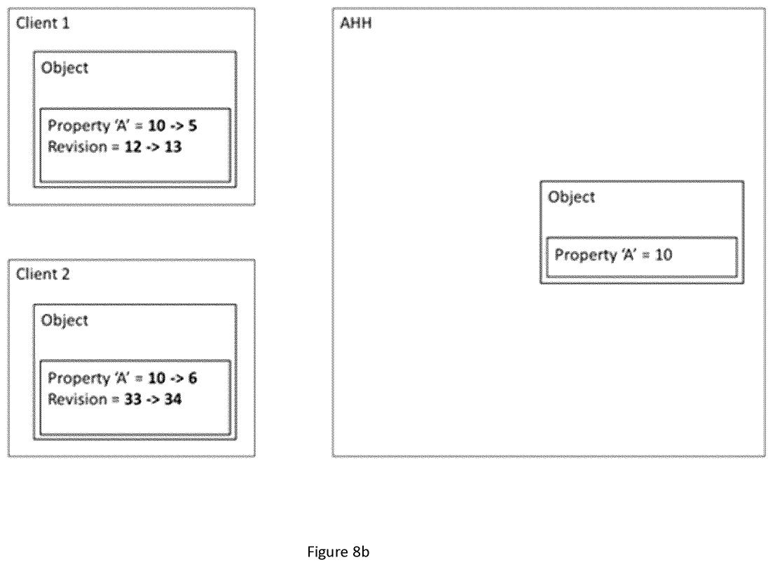

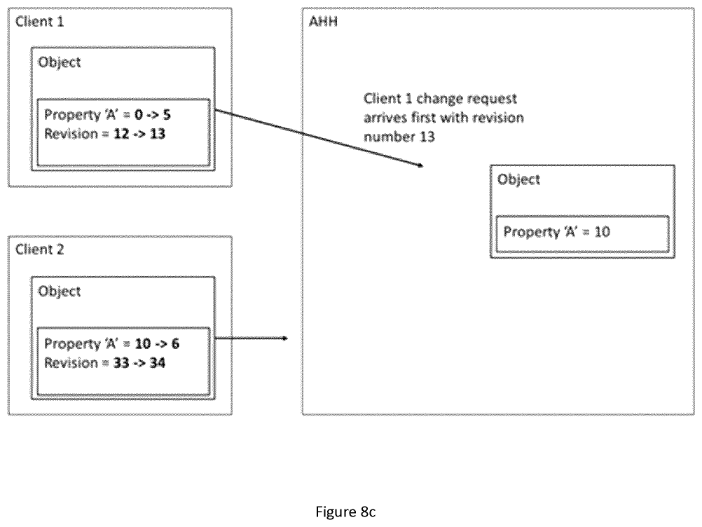

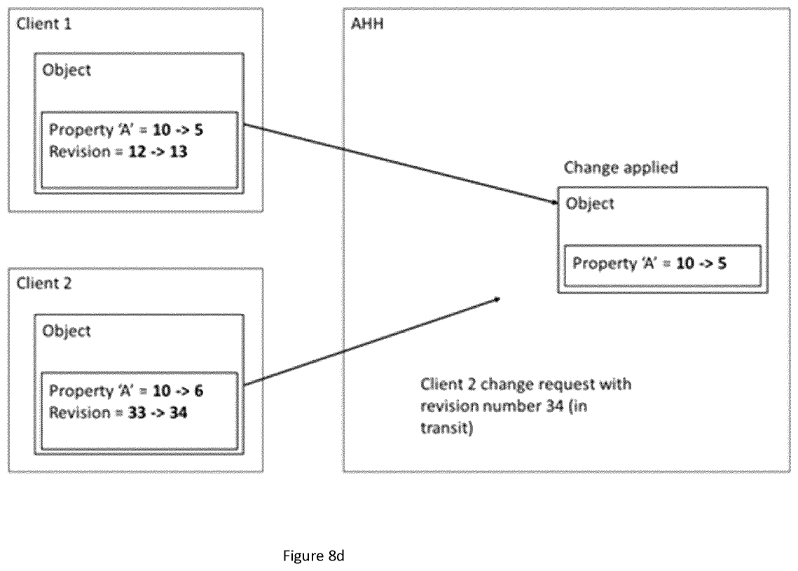

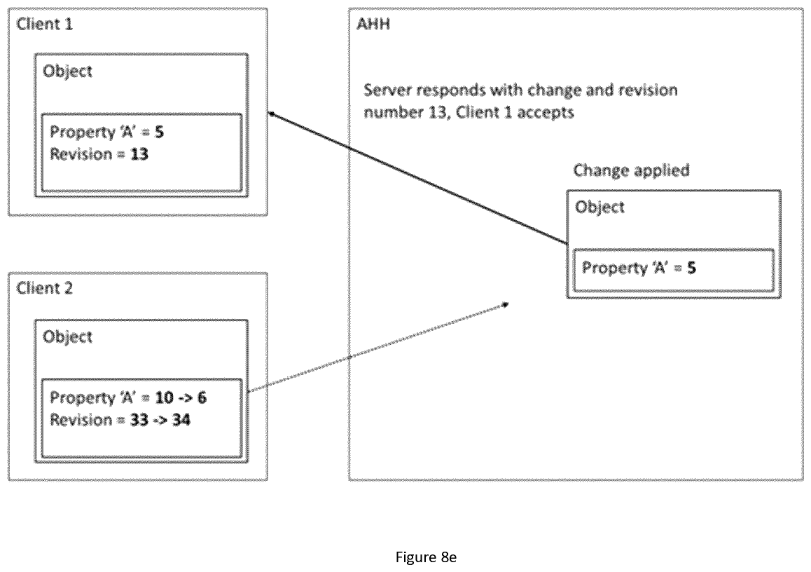

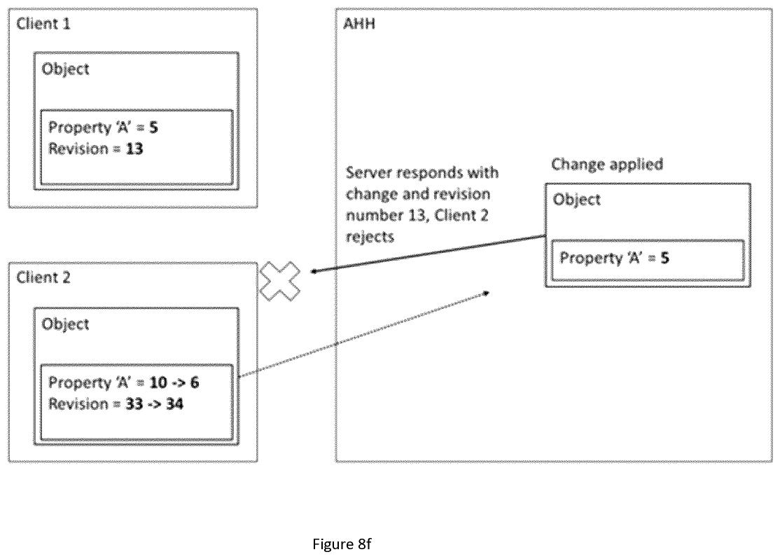

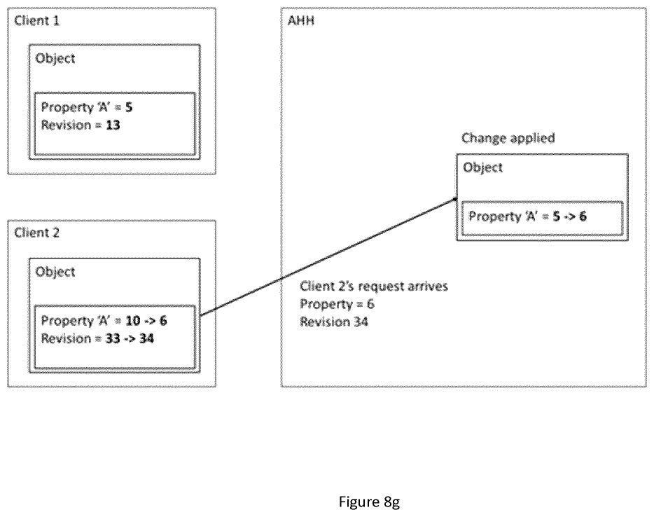

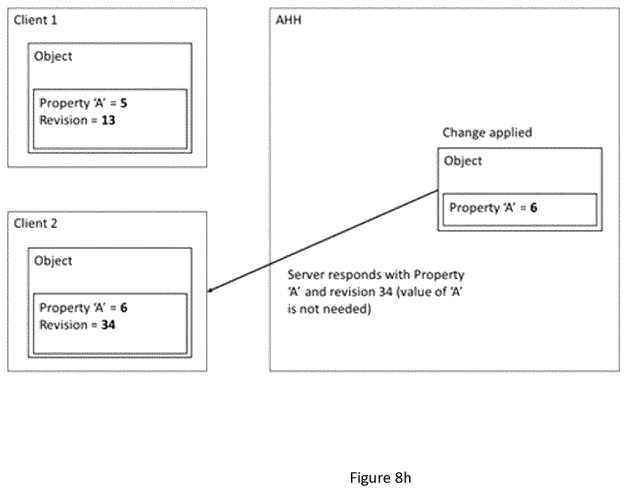

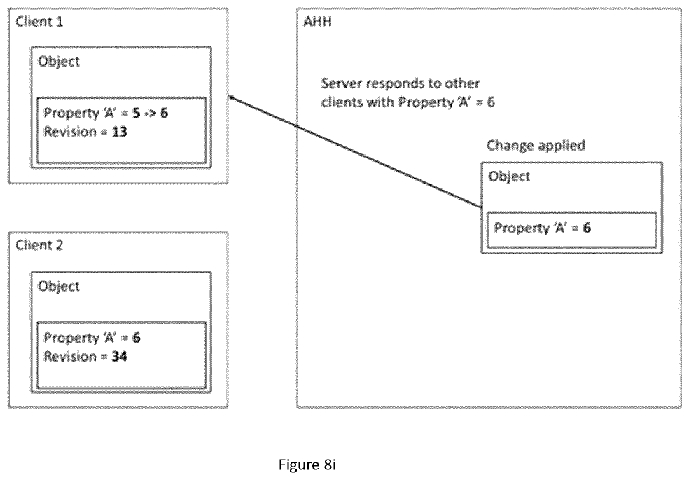

An example of how conflict resolution may be performed using this methodology is schematically shown in FIGS. 8a to 8i. It may be seen as an example where tow clients set the same property. Consider the case where two clients are connected to a server hosting an AHH.

As schematically shown in FIG. 8a, each client has a copy of the same AHH hierarchy (stored locally in the local AHH cache) which contains an object containing a property called “A” which is set to a value of 10. Each client sets a revision number for the property. For client 1, the revision number is 12 and for client 2, the revision number is 33.

If the server (or AHH) tells a client to set property “A”, but the server has not acknowledged the revision number for that property, the client will ignore the server value, because it has a more up-to-date value. The server does not check the revision number when setting a property, so whichever request it receives last will win, or control, the conflict.

As both users continue to work in the programming, or game, environment (as shown in FIG. 8b), client 1 sets property “A” to 5 and client 2 sets property “A” to 6 and both clients increment their revision number for “A” accordingly.

Both clients 1 and 2 then send their change requests to the AHH or server (such as schematically shown in FIG. 8c). It is assumed for this example that the request from client 1 is received first. Once client 1's request is received by the server, property “A” is updated to 5 (as shown in FIG. 4d). At the same time, the server receives the request from client 2 to update property “A” to 6.

In response to client 1's request, an acknowledgement is sent from the server to client 1 along with a confirmation of the revision number supplied in the request by client 1 (such as schematically shown in FIG. 8e).

Client 2 is then instructed by the server to update its version of Property “A” to a value of 5 based on the request from client 1 along with the revision number “13” which is also updated in the AHH. In response to the request from the server, client 2 does not acknowledge the update since the revision number provided by the server (or AHH) does not match its revision number for the property and is lower than the revision number (34). This is schematically shown in FIG. 8f.

As client 2 has also sent a request (as outlined above), this request is also received by the server and the server updates the value of Property “A” to 6 as per the request from client 2 which also includes client 2's revision number. This is schematically shown in FIG. 8g. After updating Property “A”, the server transmits an acknowledgement to Client 2 regarding the update along with the revision number. This is shown schematically in FIG. 8h. The server (or AHH) then transmits a message to Client 1 to update its Property “A” value to 6 along with an acknowledgement of client l's revision number since it has previously received this number. Client 1 performs the instruction from the server since the request from the server includes the revision number (schematically shown in FIG. 8i).

In another example, client 2 may set a Property along with a Sub-Property. When the server or a client gets a request to set a property, if any ancestor property has a revision number that has not been acknowledged, the request is ignored.

For example, Client 1 sets “A” to an empty dictionary with a server frame =100. Client 2 may then set “A.B” to 29 where A is a dictionary and B is a field of A with a server frame =100. When the server receives Client 1's request, the server sets “A” to an empty dictionary and sets “A”'s revision number to the current frame, 101. The server then transmits an acknowledgement to Client 1 with the updated revision number. The server may then instruct Client 2 to set “A” to an empty dictionary which, it is assumed that Client 2 does. When the server receives, or processes, the client 2 request (which is also received in server frame 100), the request is denied since the request was sent on frame 100 and ancestor property “A” as set on frame 101.

Another conflict resolution that may need to be handled may involve child conflicts. For instance, where two clients are connected to a server hosting the AHH and the AHH contains, or is storing, object A which has 3 children: B, C, and D whereby the child B is indexed as 1, child C is indexed as 2 and child D is indexed as 3.

If Client 1 sends a request to move child B to index 2 while Client 2 concurrently sends a request to insert child E at index 1, two scenarios may occur. The first scenario is when Client 1's request is responded to first and the second scenarios is when Client 2's request is responded to first.

If Client 1's request is responded to first, child B is moved to index 2 and then new child E is inserted at index 1, the resulting order for the children is CEDB.

Alternatively, if Client 2's request is responded to first, child E is inserted into index 1 and then child B is moved to index 2, the resulting order for the children is ECBD. It is beneficial for any collaboration system to behave consistently so a deterministic method of resolving conflicts is required. One method may be defined as follows:

All clients and the server must agree on what happens so that any resolution is resolved in a manner that always gets the same result, regardless of which request the server receives first. When a client receives a hierarchy operation from the server, it responds with an acknowledgement.

In one embodiment, each object on the server stores a list for each client relating to operations affecting the object's child list that the client has not acknowledged, called the child history. Typically, a client does not have to acknowledge operations they requested. When the server receives a hierarchy change request (or modification to the AHH) to insert or move a child, the index the object is being inserted at or moved to is altered by the child history, and the child history is altered according to the request. Similarly, clients store a list of hierarchy operations for each object that need to be acknowledged by the server.

There are four types of child operations that may affect the child history: insertions, removals, moves or null operations (meaning nothing happened). The first three operation types (insertions, removals and moves) may become null operations during conflict resolution.

During the conflict resolution, each operation has a source index and a destination index. The source index is the index the child was moved or removed from. It is assigned a value of −1 for insertions or null operations. The destination index is the index the child was moved to or inserted at and has a value of −1 for removals or null operations. In order to control this, within each client, the client includes a pointer to the child object that the operation affected while within the server (AHH). In some embodiments, the server may store the child object's id in some situations based on the operation performed.

Each object on the client stores, or includes, a list of parents the object had for unacknowledged operations, called the parent history. The history may contain nulls if the child used to be a root object. This is used for rolling back when hierarchy requests are denied due to locks.

One process for the server or AHH receiving a hierarchy request is as follows:
The server receives a requested operation, R, from a client to insert, move, or remove a child.
The server retrieves the child history from the parent object for the client who made the request.
For each operation O in the child history, starting from the oldest operation to the newest:
   O's indexes are adjusted to what they would be if R had happened first, creating a new operation O′. If O and R are both insertions at the same index, the destination index for O′ is not changed.
   R's indexes are adjusted to what they would be if O had happened first. If
   and R are both insertions at the same index, R's destination index is incremented.
   O′ replaces O in the child history.
   If R is a null operation, the process may be seen as completed.
R is then applied to the hierarchy.
R is appended to the child history for the parent for all clients except the client who made the request.
The server sends an acknowledgement for R to the client who made the request.
Each client except for the one who made the request is told about operation R.
The server receives acknowledgment for R from each client other than the one who made the request. When the server receives an acknowledgement from a client, it removes the first operation in the child history for that client that does not have a child id.

One embodiment of a process for a client making a hierarchy request is as follows:
The client makes a request R to insert, move, or remove a child. R is appended to the parent's child history.
The child's original parent is added to the child's parent history. If the child was a root object, null is added to its parent history.
The client receives an acknowledgment from the server. The client removes the first operation from the parent's child history and removes the first parent from the child's parent history.

One embodiment of a process for a client receiving a hierarchy operation from the server of AHH is as follows:
The client receives a hierarchy operation, R, to insert, move, or remove a child.
For each operation O in the child history for the parent, starting from the oldest operation to the newest:
   O's indexes are adjusted to what they would be if R had happened first, creating a new operation O′. If O and R are both insertions to the same index, the destination index for O′ is incremented.
   R's indexes are adjusted to what they would be if O had happened first. If O and R are both insertions at the same index, R's destination index is not changed.
   O′ replaces O in the child history.
   If R is a null operation, the process is seen as completed.
R is applied to the hierarchy.
The client sends an acknowledgement to the server for R.

One process for adjusting the indexes of operation A to what they would be if operation B happened first is as follows:
If A is an insertion:
   If B is a move:
      If B's destination index is less than A's and B's source index is less than or equal to A's destination index:
         Increment A's destination index
      If B's source index is less than A's destination index and B's destination index is greater than or equal to A's:
         Decrement A's destination index
   If B is an insertion:
      If B's destination index is less than A's:
         Increment A's destination index
      If B and A have the same destination index, we might increment A's destination index, depending if this is the server or client and which operation we are adjusting, as described previously.
   If B is a removal:
      If B's source index is less than A's destination index:
         Decrement A's destination index
If A is a removal:
   If B is a move:
      If B's source index is A's source index:
         Set A's source index to B's destination index
      If B's destination index is less than or equal to A's source index and B's source index is greater than A's:
         Increment A's source index
      If B's source index is less than A's and B's destination index is greater than or equal to A's source index:
         Decrement A's source index
   If B is an insertion:
      If B's destination index is less than or equal to A's source index:
         Increment A's source index
   If B is a removal:
      If B's source index is the same as A's
         Set A's source index to −1, making A a null operation.
      If B's source index is less than A's
         Decrement A's source index
If A is a move:
   Create A′ which is a copy of A
   If B is a move or an insertion:
      If B's destination index is less than A's or
      If B's destination index is same as A's and (B's source index is greater than A's or (B is an insertion and A's source index is greater than A's destination index)):
         Increment A's destination index
      If B's destination index is less than A's source index or
      If B's destination index is the same as A's source index and (B's source index is greater than A's or B is an insertion):
         Increment A's source index
If B is a move or a removal:
   If B's source index is less than A's:
      Decrement A's source index
   If B and A's source indexes are the same:
      If B is a removal:
         Set A′ to the null operation
      If B is a move:
         Set A's source index to B's destination index
   If B's source index is less than A's destination index or
   If B's source index is A's destination index and A's destination index is greater than A's source index:
      Decrement A's destination index
   Set A to A′

In the above example, this is what happens when the server gets client 1's request first: Client 2's child history for A will have client 1's operation to move B from index 0 to index 2. The server gets client 2's request to insert E at 1 but since it can be seen in the child history that the child at index 0 was removed, the insertion index is decremented and E is inserted at 0. Because a child was inserted at index 0, child B's index is increased, so the child history for client 2 now has the child at index 0 moved to index 3. The resulting child order is ECDB.

With respect to the clients in this process, Client 1 processes the operations in the same order as the server. First it makes its request to move B from 0 to 2 and stores that operation in its history. The server acknowledges the operation and it is removed from the history. The server tells Client 1 to insert E at 0 such that the result for Client 1 is ECDB. Client 2 processes the operations in the opposite order, so conflict resolution is used to get the same result. First client 2 inserts E at 1 and has BECD, and its history has E inserted at 1. The server tells client 2 to move B to 2, but because the history has E inserted at 1, the destination index for B is incremented to 3, resulting in ECDB.

There may be situations where child changes may need to be reverted. As previously discussed, the server or AHH may deny one or more requests to change the hierarchy due to locks. The client who made the request(s) will need to undo the changes locally.

For the server, this process may be seen as follows:
The server receives a requested operation, R, from a client to insert, move, or remove a child C.
The child C is locked by another user, so the server denies the request.
The server gets the child history from the parent object for the client who made the request.
The server creates R⁻¹, the inverse of R by swapping R's source and destination indexes. C's id is stored in R⁻¹.
The server prepends R⁻¹ to the client's child history. Clients send acknowledgements to the server for failed operations where the acknowledgment contains a parent id P and a child id C. When the server receives an acknowledgement for failed operations, for parent P and child C, the process is as follows:
For each operation O in P's child history, starting from the oldest to the newest:
   If O operates on C:
   For each operation N that occurred before O, starting from the oldest to the newest:
      N's indexes are adjusted to what they would be if O had happened first, creating a new operation N′. If N and O are both insertions to the same index, N′'s destination index is incremented.
      O's indexes are adjusted to what they would be if N had happened first. If N and O are both insertions at the same index, O's destination index is not changed.
      N′ replaces N in the child history.
      If O is a null operation, stop.
         Remove O from the child history

The process on the client when a child C becomes locked may be as follows:
The client is told C got locked by another user.
If C has a non-empty parent history:
   The client removes the first parent, P, from C's parent history.
   If C's parent is not null and is not P, the client sends an acknowledgment for the failed child operation(s) to the server for C's parent as the parent and C as the child.
   If P is not null:
      Remove all operations for C in P's child history and adjust other operations to what they would be if C's operations never occurred. Get the index C would have if those operations never occurred. This process is described in more detail below. If that index is greater than or equal to 0 (meaning C is still a child of P):
         If C's parent is not P, remove it from its parent.
         Make C a child of P at the index.
         Send an acknowledgement for the failed child operation(s) to the server for P as the parent and C as the child.
   If P is null and C's parent is not null:
      Make C a root object
   For each parent Q in C's parent history:
      Remove all operations for C in Q's child history and adjust other operations to what they would be if C's operations never occurred.
      Send an acknowledgement for the failed child operation(s) to the server for Q as the parent and C as the child.
   Clear C's parent history
If C is fully locked:
   Revert all unacknowledged child operations for C and restore its children to match the server. This process is described in detail below.

One process to revert all unacknowledged child operations for a parent P and restore its children to match the server may be as follows:
While P's child history is non-empty:
   Remove the last operation O from the child history
   Create O⁻¹, the inverse of O by swapping O's source and destination indexes.
   Get the child C that was affected by O.
   Remove all operations for C in P's child history and adjust other operations to what they would be if C's operations never occurred. Get the index C would have if those operations never occurred. If there were no operations for C, get the destination index from O⁻¹.
   Get the first parent F from C's parent history. If C's parent history is empty, F is C's current parent.
   If F is P:
      For each parent Q that is not P in C's parent history:
         Remove all operations for C in Q's child history and adjust other operations to what they would be if C's operations never occurred.
         Send an acknowledgement for the failed child operation(s) to the server for Q and the parent and C as the child.
      Clear C's parent history
      If C is a child the client tried to create whose creation was not confirmed by the server and P exists on the server:
         Remove all occurrences of P from C's parent history
         Revert all unacknowledged child operations for C and restore its children to match the server, by going to the start of this section, using C as the new P.
         Delete C and move to the top of the outermost loop
      If C's parent is not P, remove it from its parent.
      Make C a child of P at the index
   If F is not P:
      Remove all occurrences of P from C's parent history
      If C's current parent is P:
         Remove the last parent L from C's parent history.
         If L is not null:
         Remove the last operation for C in L's child history and adjust other operations to what they would be if that operation never occurred. Get the index C would have if that operation never occurred.
         Make C a child of L at the index
         Send an acknowledgement for the failed child operation(s) to the server for L as the parent and C as the child.
         If L is null:
         Make C a root object

One process to remove all operations for a child C from a child history, adjust the other operations to what they would be if C's operations never occurred, and get the index C would have if those operations never occurred, may be as follows:
For each operation O in the child history that operates on C, from the newest to the oldest:
   Create O⁻¹, the inverse of O by swapping O's source and destination indexes.
Remove O from the child history
   For each operation N that occurred after O in the child history, starting from the oldest to the newest:
      N's indexes are adjusted to what they would be if O⁻¹ had happened first, creating a new operation N′. If N and O⁻¹ are both insertions at the same index, N′'s destination index is not changed.
      O⁻¹'s indexes are adjusted to what they would be if N had happened first. If N and O⁻¹ are both insertions at the same index, O⁻¹'s destination index is incremented.
      N′ replaces N in the child history.
      If O⁻¹ is a null operation, stop.
O⁻¹'s destination index is the index C would have if C's operations never occurred.

If there were no operations for C, the index is —1.

As an example, assume object A has children B, C, and D. Client 1 makes a request to remove C and inserts E at index 2, resulting in BDE. However, before the server receives Client 1's request to remove C, another client locks C. When the server receives client 1's request to remove C, the request is denied because C is locked. The server or AHH then adds the inverse of the denied operation to client 1's child history for object A, so the history contains an insert at index 1. Next the server gets the request to insert E at 2, but because the history contains an insert at a lower index, the destination index is incremented to 3, resulting in BCDE. On Client 1, the child order is BDE (due to the edit to remove C and insert E as outlined above) and the history contains a remove at index 1 and an insert at index 2. When client 1 is told that C became locked, the client knows it must undo all hierarchy operations for C. Each object on the client maintains a history of parents it had for unacknowledged non-insert hierarchy operations, so it knows that it used to be a child of A, and from A's child history it knows its index was 1. C is reinserted at index 1, and the removal at index 1 is removed from A's child history. As this operation (or reversal) affects all operations that occurred after it, all other operations or manipulations must be adjusted to what they would be if this operation never happened. For this example, the other operation in the history, inserting E at 2, is changed to an insert at 3. Client 1 now has the correct child order of BCDE. The client sends an acknowledgement to the server that it undid or reversed the denied operation for C, and the server removes the insert of C at index 1 from A's history for Client 1.

The same conflict resolution strategies may also be used to handle conflicting requests on list properties. When an object with a list property becomes locked, the unacknowledged list operations are played in reverse to revert the list back to the server state.

A further functionality that may be provided by the system of the disclosure is the subscription, or association, of objects by clients. When objects are created, they may be given a flag that instructs the AHH whether or not to sync the children of the object to clients that are subscribed to an object. For clients that are not subscribed to an object, the object will appear to those clients as having no children.

Communication between a client and the AHH may include different requests from the client. As understood, the messages from the clients to the AHH are received by the networking layer and then parsed by the data interpretation layer.

In one specific implementation of communication between clients and the server, or AHH, the communication may be implemented as discussed below.

One request that a client may transmit to the AHH is a request create command to request a creation of one or more objects. Parameters within this command may include a number of objects to create (not including children) and an identification of any parent object for the new one or more objects. If the new objects have a parent, further parameters, such as, the child index where the new object is to be inserted (which may be changed after conflict resolution), a last server frame number received by the client and serialized object data for each object. The serialized object data may include a new object identification, an object type string and flags for controlling a behavior of the object. Flags may include, but are not limited to, an optional children flag that, if set, causes children of the object to not be synced to clients unless the client is subscribed to receive the object's children and a transient flag that, if set, causes the object to be deleted when the client that created the object disconnects from the AHH, or server.

The serialized object data may further include serialized property data, an identification of any client that has a direct lock on the object, the number of child objects to create and serialized object data for each child object.

When the AHH receives a request create command, the AHH will either create the objects or deny the request based on the locking strategies described above. A create acknowledgement is sent to the client who sent the request, regardless of whether the request is accepted or not. If new objects are created, they are serialized and transmitted to all other clients working in the game environment.

If the identification for an object provided by the client is already in use by another object, that object and any of its children will not be created. If the new objects have a parent, any objects that are not created because of conflicting identification have an inverse insertion operation prepended to the request sender's child history associated with the object that was not created.

If new objects are to be created, the AHH may transmit a create command to the clients working in the game environment. Typically, this create command would not be transmitted the client that made the request create command, however, in some embodiments, this may be performed.

The create command may include parameters such as, but not limited to, the number of objects to create (not including the child objects) and an identification of the parent object for new objects if the new objects have a parent. If the new objects have a parent, the AHH may also transmit a child index instructing the clients where to insert the new object and serialized object data for each object. This serialized object data may be the same as the data sent in the request create command. If one of the new objects has the same identification as another object the client requested be created whose creation is not acknowledged yet, the object whose creation is pending is deleted and its parent history and child operations are reverted using the algorithms described above.

The client may also transmit a request delete command. Parameters within this command may include an identification of the object to be deleted and the last server frame number the client received with respect to the object to be deleted. If the object to be deleted has a parent, the identification of the parent along with the child index of the object to be deleted may also be provided in the request delete command.

If deletion is denied by the AHH (due to conflict resolution, such as discussed above), but edits to the parent's children are allowed, an inverse remove operation may be added within the parent's child history for the client using the supplied parent identification and child index.

In one embodiment, when transmitting the request delete command, the client needs to send the parent identification and child index of the object at the time it makes the request, as they may be different from the current parent identification and child index. If deletion succeeds, the server transmits a message to all other clients working in the game environment to delete the object.

If new objects are to be deleted, the AHH may transmit a delete command to the other clients working in the game environment. The delete command may include parameters such as, but not limited to, the identification of the object to be deleted. If a client that receives the delete command has a lock on the object, the on confirm delete functionality (described above) is invoked, otherwise, the on delete functionality is executed.

Another command from the client to the server may be a request lock command. Parameters within this command may include an identification of the object to be locked and the last server frame number the client received. From the view of the server or AHH, the lock is granted or denied based on confliction resolution activities performed by the AHH. If the lock is granted, the AHH informs all clients that a lock has been placed on the object by the requesting client.

If an object is to be locked, the AHH may transmit a lock command to the clients working in the game environment along with the client that transmitted the request lock command. The lock command may include parameters such as, but not limited to, the identification of the object that is locked and an identification of the client that owns the lock.

When the lock owner receives the lock command, the client increments the acknowledged revision number on the object to indicate the server acknowledged all property changes the client made since locking the object. If the client that receives the lock command is not the lock owner, the client reverts to the unacknowledged list, child, and parent changes as described in the child conflict resolution section and invokes the On Lock functionality to lock all objects, either directly or indirectly. The On Direct Lock Change functionality may also be executed or invoked.

Another command from the client to the server may be a request release lock command. Parameters within this command may include an identification of the object to be locked. Once the AHH determines that the client that transmits the release lock command has a lock on the object, the server releases the lock and then informs all other clients working in the game environment that the object is not directly locked anymore.

If an object is to be released or unlocked, the AHH may transmit an unlock command to the clients working in the game environment, and, in some embodiments, the client that transmitted the release lock command. The unlock command may include parameters such as, but not limited to, the identification of the object that is being unlocked. If the lock owner is another client, the client executes the On Unlock functionality for any objects that are being unlocked. The On Direct Lock Change functionality may also be executed.

Another command from the client to the server may be a request detach parent command which enables an object to be detached from its parent to become a root object. Parameters within this command may include an identification of the object to be detached, the last server frame number the client received; the identification of the parent to detach from; and the child index from which the object is being removed.

If the request for detachment is denied but edits to the parent's children are allowed, an inverse remove operation in the parent's child history is added for the client making the detach parent command using the supplied parent identification and child index. Typically, the client needs to send the parent identification and child index of the object at the time it made the request, as they may be different from the current parent and child index. If the detachment succeeds, the server may transmit a child acknowledgement for the parent to the client making the request and tells all other clients working in the game environment to detach the object.

If the detached child used to be a descendant of an object whose children are not synced to clients unless they are subscribed to the object, the server will send all clients who were not subscribed to the object a create command, and it will appear to them as if the detached object were newly created.

If the object is to be detached from the parent, the AHH may transmit a detach parent command telling the other clients to detach an object from its parent. The detach parent command may include parameters such as the identification of the object that is being detached. These clients may then execute the on parent change functionality.

Another command from the client to the server may be a request attach parent command which enables an object to become a child of a parent object. Parameters within this command may include an identification of the object to be attached, an identification of the parent to which the object is being attached, an index where the child is to be inserted and the last server frame number the client received. If the object already has a parent, further parameters such as the identification of the old parent and the child index of the old parent should be included.

If the child is already attached to the parent, or attaching it to the parent would create a circular reference, the server, or AHH, ignores the command. If the attachment is denied but edits to the new parent's children are allowed, an inverse insert operation in the new parent's child history for the client is added. If the attachment is denied but edits to the old parent's children are allowed, an inverse remove operation in the old parent's child history for the client is added using the supplied parent identification and child index.

The client needs to send the old parent identification and child index of the object at the time it makes the request, as they may be different from the current parent and child index.

If the attachment succeeds, the server transmits a child acknowledgment to the client that sent the command, and if the object had an old parent, sends another child acknowledgment for the old parent. The server then informs all other clients about the attachment (such as discussed below).

If some clients were not subscribed to receive children from the child's original parent (or ancestors), but are subscribed to receive children for the new parent (and ancestors), the server will send those clients a create command, and it will appear to them as if the child is a newly created object. If some clients were subscribed to receive children from the child's original parent (and ancestors), but are not subscribed to receive children for the new parent (or ancestors), the server will send those clients a delete command, and it will appear to them as if the child were deleted.

If the object is to be attached to a parent, the AHH may transmit an attach parent command telling the other clients to attach the object to a new parent. The attach parent command may include parameters such as the identification of the object that is being detached; an identification of the parent to which the object is being attached and an index where the child is to be inserted. These clients may then execute the on parent change functionality.

Another command from the client to the server may be a request move child command enabling a child object to be moved to a new index. Parameters within this command may include an identification of the child object; an identification of the parent object; the index from which the child is being moved; the index to which the child is being moved and the last server frame number the client received.

If the move is denied by the server but edits to the parent's children are allowed, an inverse move operation to the parent's child history for the client is added using the supplied parent identification and the to and from indexes. The client needs to send the parent identification and old child index at the time it makes the request, as they may be different from the current parent and child index. If the move succeeds, the server transmits a child acknowledgment to the client transmitting the request move child command and informs all other clients about the move.

If the child object is to be moved, the AHH may transmit a move child command telling the other clients to move a child object. The move child command may include parameters such as the identification of the child object that is being moved and the index to which the child is being moved. These clients may then execute the on parent change functionality.

Another command from the client to the server may be a request property change command which enables a change to be made to a property value. Parameters within this command may include an identification of the object the property belongs to; the last server frame number the client received; the revision number for the server to send back in an acknowledgment if the property change is allowed and the request sender does not own a lock on the object; the path to the property and the serialized property value.

The server uses the conflict resolution strategies described in earlier sections to determine if the property change is allowed. If the change is denied because of object locks, the server sends a set property message with the current server value to the client making the request, so that the client will set its local property back to the server value. If the change is allowed and the client making the request property change command does not own a direct lock on the object, the server sends the revision number from the request back to this client and informs all other clients about the property change.

If the property change is allowed, the AHH may transmit a set property command telling the other clients to set a property. The set property command may include parameters such as the identification of the object the property belongs to; a path to the property and the serialized property data. Each client uses the revision number conflict resolution methodology to determine if it should set the property. If it does set the property, the On Property Change functionality is invoked.

Another command from the client to the server may be a request remove field command enabling a field to be removed from a dictionary property. Parameters within this command may include an identification of the object the property belongs to; the last server frame number the client received; the path to the dictionary property; and the name of the field to remove.

In response to the command, the server or AHH uses conflict resolution strategies to determine if the field removal is allowed. If the removal is denied because of object locks, the server sends a set property message with the field value to the client making the request remove field command, so the client will set its local field back to the server value. If the removal is allowed, the server informs all other clients about the removed field.

If the field removal is allowed, the AHH may transmit a remove field command telling the other clients remove a field from a dictionary property. The remove field command may include parameters such as the identification of the object the dictionary property belongs to; the path to the dictionary property and the name of the field to remove. The client may then use the revision number conflict resolution strategy to determine if it should remove the field. If it does remove the field, the on remove field functionality is invoked.

Another command from the client to the server may be a request add to list command which enables properties to be added to a list property. Parameters within this command may include the identification of the object the property belongs to; the last server frame number the client received; the path to the list property; the index where the properties is to be inserted (which may change after conflict resolution); the number of properties to insert; and the serialized property data for the new properties to insert.

In response to the command, the server or AHH uses conflict resolution to determine if the insertion is allowed and index which the properties are to be inserted. If multiple properties are inserted at once, each inserted property is treated as one operation when applying the child conflict resolution algorithm. If the insertion is allowed, the server informs all other clients about the inserted properties.

If the add to list is allowed, the AHH may transmit an add to list command telling the other clients to add properties to a list property. The add to list command may include parameters such the identification of the object the list property belongs to; the path to the list property; the index where the properties are to be inserted; the number of properties to insert and the serialized property data for all properties to insert.

Each client that receives the add to list command uses conflict resolution to determine if and at which index properties should be inserted. The on list add functionality is invoked if properties are inserted.

Another command from the client to the server may be a request remove from list command which enable properties to be removed from a list property. Parameters within this command may include the identification of the object the property belongs to; the last server frame number the client received; the path to the list property; the index from where the properties are to be removed (which may change after conflict resolution); and the number of properties to remove.

In response to the request remove from list command, the AHH uses conflict resolution strategies, such as those described above, to determine if the removal is allowed and what indexes to remove the properties from. If multiple properties are removed at once, each removed property is treated as one operation when applying a child conflict resolution algorithm.

If the removal is allowed, the AHH may transmit a remove from list command telling the other clients working in the game environment to remove properties from a list property. The remove from list command may include parameters such as the identification of the object the list property belongs to; the path to the list property; the index where the properties are to be removed; and the number of properties to remove.

Each client that receives the remove from list command uses conflict resolution to determine if and at which index properties should be removed. The on list add functionality is invoked if properties are removed.

The client may also transmit a request subscribe command or a request unsubscribe command to the AHH.

The request subscribe command enables a client to subscribe to an object, syncing the object's descendants to the client making the command. This is only needed if the object was created with a flag to require a subscription to sync children. Parameters for the request subscribe command may include the identification of the object to which the client wishes to subscribe. If the subscribed object has any children, the server will send the requesting client a create command with all the child data along with an acknowledgement of the subscription.

The request unsubscribe command enables a client to unsubscribe from an object, which stops syncing the object's descendants to the client making the request. This only works if the object was created with a flag to require a subscription to sync children. Parameters for the request unsubscribe command may include the identification of the object to unsubscribe from. The server also removes all direct locks the requesting client owns from descendants of the unsubscribed object and responds by acknowledging the unsubscription.

If either a subscription or unsubscription is allowed, the AHH transmits an acknowledge subscription command or message to the requesting client. Parameters for the acknowledge subscription command may include the identification of the object the acknowledgement is for and whether the acknowledgment is for a subscription or an unsubscription.

If the acknowledgement is for an unsubscription, the requesting client deletes all the children of the object locally, but does not invoke deletion events. The client may then execute the On Acknowledge Subscription functionality.

The client may also transmit an acknowledge child operations command or message to the server that acknowledges one or more child operations. Parameters for this command may include the identification of the parent object of the childe that the child operations are being acknowledged. If the command is being transmitted to acknowledge denied child operations, the parameters may further include the identification of the child the denied operations affected; and a flag to decide if acknowledge all denied child operations that affected the child should be acknowledged or only the most recent one. Otherwise, the parameters may include the number of operations to acknowledge. The first predetermined number of operations that have no child identifications are acknowledged.

The acknowledged child operations are then removed from the requesting client's child history for the object such as discussed above.

Another message that may be transmitted from the client to the server is an acknowledge list operations command or message. This enables acknowledgement of one or more list operations. Parameters for this command may include the identification of the object to acknowledge list operations for; the last server frame number the client received; the path to the list property; and the number of list operations to acknowledge.

The acknowledged list operations are removed from the requesting client's list history for the list. If changes to the list's properties are denied based on the server frame number sent in the request, no operations are acknowledged.

The server may also transmit other messages or commands to the clients. One such message or command may be an acknowledge create command or message that may be used to acknowledge a creation request from a client, regardless of whether that creation request was accepted or denied.

When the client makes a request to create objects, the requesting client stores an array of all new objects from the request in a pending create queue. These objects are in a pending create state until the server acknowledges the request create command. If an object in the pending create state fails to be created for any reason, such as the parent becoming locked before the object's creation is acknowledged, or another object with the same identification being created before the object is acknowledged, the object's pending create state is cleared and a cancel create counter on the object is incremented.

When a creation acknowledgement is received, the oldest list of objects is removed from the pending create queue. Any objects with a cancel create counter higher than O have their cancel create counter decremented. All other objects move from the pending create state to the created state.

Another message or command that the server may transmit to at least one client is an acknowledge child operations command or message to acknowledge one or more child operations for an object. Parameters for the acknowledge child operations command may include the identification of the object to acknowledge a child operations for and the number of child operations to acknowledge. Once a client receives this acknowledge child operations command, the acknowledge child operations are removed from the child history.

Another message or command that the server may transmit to at least one client is an acknowledge property command or message to acknowledge property changes on an unlocked object. Parameters for the acknowledge property command may include the identification of the object to acknowledge property changes for and the revision number to acknowledge. Once received by a client, the client sets the acknowledged revision number of the object. This message may be used for conflict resolution.

Another message or command that the server may transmit to at least one client is an acknowledge list operations command or message to acknowledge one or more list operations for a list property. Parameters for the acknowledge list operations command may include the identification of the object the list property belongs to; the path to the list property; and the number of operations to acknowledge. Once received by the client, the client removes the acknowledged list operations from the list history.

In some instances, when multiple clients are using the same programming environment, one or more of the clients may be missing assets that are present in the programming environment of at least one of the other clients. In this embodiment, stand-ins may be used.

When a user (or client) is missing an asset that at least one other client has in their programming environment, the client missing the asset may receive a stand-in to represent the asset. For invisible assets this may be displaying as a question mark in the programming environment of the client missing the asset.

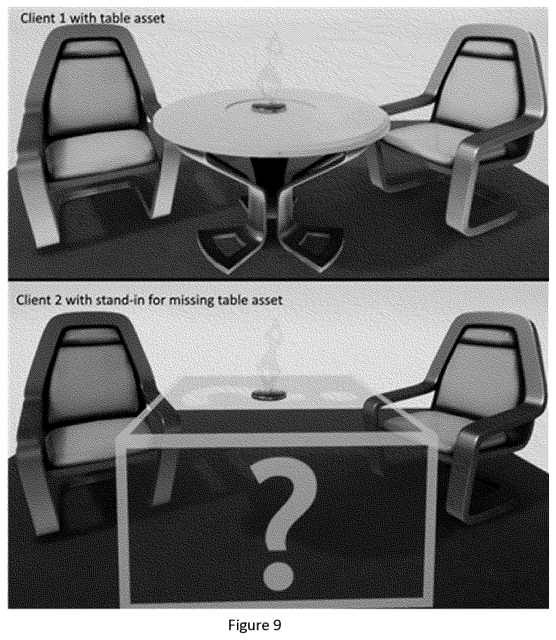

For meshes and visible assets, a box with questions marks may be shown or displayed matching the dimensions of the missing mesh. When the asset is inspected, a path to the missing asset may be, or is, displayed. If the user copies and pastes a reference to the stand-in asset, all other users that have the correct asset will get a reference to the correct asset instead of the stand-in. When the missing asset becomes available, all stand-ins for that asset are replaced with the correct asset. This is schematically shown with respect to FIG. 9.

In some scenarios, the loading of complicated assets in some editors or authorizing environments may be delayed due to extra processing, causing the editor to freeze for several seconds. This interrupts workflow when a user adds a new asset to a level and all other users (or clients) have their authoring environment freeze despite not taking action to cause it.

To avoid this delay, the system may reduce or eliminate the delay by performing a process such as described below. User activity is monitored by the client to track input events from all sources, such as, but not limited to, mouse, keyboard, and VR equipment. The process to determine if the user is ‘idle’ is to detect when the user has not provided any inputs within a time window. This time window can be fixed or adjusted based on the users measured rate of inputs.

In some embodiments, when a user or developer performs an undo or redo operation, the plugin detects the changes and sends at least one request to the server for changes on unlocked objects and revert changes on locked objects. From the perspective of the AHH, undo and redo changes are processed the same way as any other changes.

In some embodiments, for object identification and for merging “offline” updates or changes, when the game environment is modified by a single client in an ‘offline’ scenario, these “offline” changes must be identified so that they can be merged with potential changes made by other clients. To facilitate this capability, each client's contributions may be seen as being unique and therefore can be identified separately.

Typically, there are three types of changes that need to be tracked which may be seen as adding new objects, modifying existing objects, and removing existing objects.

To accomplish this, an AECP assigns unique IDs (GID) to each object within the game environment. This GID is bound to the object itself, so any other user or clients editing the same game environment must also use that GID to reference that same object.

The AECP plugin is used on each of the clients that do not assign GIDs to hierarchy objects in a deterministic manner. The GIDs are stored on their respective objects as components.

When clients connect to the server (after being offline), the server assigns GIDs to objects that do not have one provided by the AECP. The server ensures that every object in the AHH is assigned a GID.

If a client connects when its hierarchy has been modified when not connected to the server, such as when the client is off-line, the client compares the objects in the AHH to its local hierarchy once it comes back online to ensure the programming environment is up to date. Any objects it finds that do not have GIDs get GI Ds assigned, and are added to the AHH, which then is replicated to all other connected clients.

In another embodiment, developers may create large worlds using terrain or landscape data. Terrains may include multiple different kinds of data, including, but not limited to: heightmap data (a two-dimensional map containing the height of the terrain at each X, Y point); mesh data (standard piece of 3D geometry including vertices in 3D); splat or texture map data (a list of textures to render, and a two-dimensional map for each texture with weight values from 0 to 1 that determines the alpha value to multiply that texture by at each X, Y, point on the terrain); and/or tree/foliage data (depending on the engine, the terrain may have different implementations of tree and/or foliage data). For instance, the implementation may be a list of all trees/foliage instances and their X, Y positions, rotations, scales, colors, and any other relevant data within the game environment or the implementation may include two-dimensional maps for deterministically generating foliage using weights that control foliage density.

In one embodiment, the terrain may be divided spatially into a grid with each cell of the grid seen as a subsection. The data for each subsection and each data type (heightmap, splat map, foliage, etc) is extracted and compressed separately, then sent to the server. The compressed data for each section and type is sent as a binary array property, so the same conflict resolution rules described previously apply for terrain. The server keeps a copy of the compressed data to send to new clients. When a user starts editing terrain on their local client, a timer is started. While the timer is counting down, all subsections of the terrain that were altered by the user are tracked. If the game engine, or authoring environment, does not provide a notification or event for which subsections were altered, it must be computed. This is done by finding the point where the user's mouse intersects the terrain and using the bounding box of the user's terrain brush to determine the affected area, and then find which subsections intersect the affected area. When the timer reaches zero, the relevant data from each altered subsection is compressed and sent to the AHH, which sends it to all clients connected to the AHH to decompress and apply it to their terrain.

When a user is editing terrain and their mouse is over the terrain, other users can see an indicator rendered on the terrain showing where that user's mouse is. This effect is accomplished by sending mouse data from the client to the AHH when the client is editing terrain. This data is stored using a special input object in the AHH containing the mouse coordinates, brush id, and terrain id. This object is synced to all other clients, and their AECP uses the data in the input object to project the terrain painting brush indicator for all other clients in their respective authoring environments.

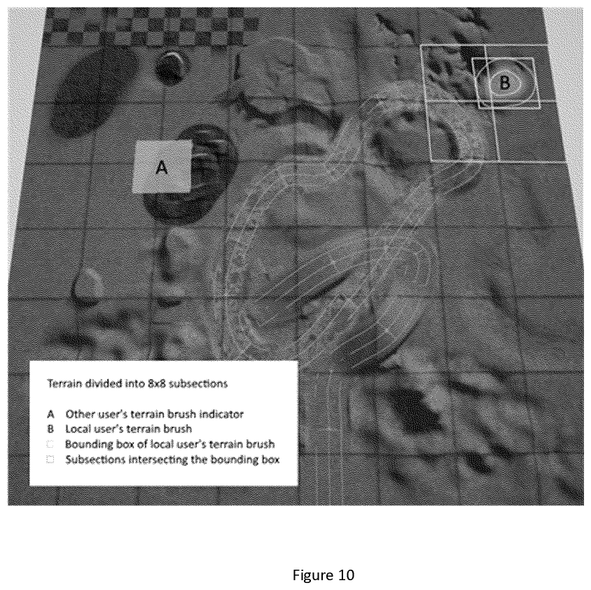

Terrain objects can be locked when selected by a particular client, preventing other clients from performing edits or reducing the likelihood that other clients can perform edits until that particular client has deselected the terrain. Changes can still be synchronized in real-time as schematically shown in FIG. 10.

Another functionality of the current system is to record user actions, such as for analytic purposes and/or playback. In one embodiment, user actions that are recorded are limited to events generated in the client application (programming environment) which are sent to the server. Only events that are accepted by the server may be recorded. With these events, the state of a scene at distinct periods of development may be reproduced.

In another embodiment, the system may include a data compression system to enable the fast set-up of large or complex scenes. In another embodiment, the disclosure may include sub-scene support functionality that allows multiple scenes to be represented as parts of the whole, and optionally loaded on individual clients. In yet another embodiment, the disclosure may include functionality to handle tolerance to differences in the project files present on the various connected clients, with regards to components that contain data properties and code-based assets. In yet another embodiment, the disclosure may include functionality to enable real-time object locking and unlocking. In another embodiment, the disclosure may include functionality to perform real-time conflict resolution. In yet another embodiment, the disclosure may provide a stand-in system that provides a visualization and/or placeholder on a client for assets that are missing, pending loading, or being placed by a different connected client.

For instance, this may be beneficial for playback which may be seen as a replay of the creation of a scene while watching from different angle and focusing on different objects and properties. It may be beneficial for scene differences where two different versions of the scene are generated using different object states and then compared. Recording may also be useful in auditing the development process where the server may follow a specific user or object and track its involvement in the editing session. Another benefit may be in rollbacks which allows the server to revert a project (or programming environment) to an earlier point during the editing session. Finally, it may find benefit in analytics where recorded data is mined for build statistics.

In this description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments described herein are implemented as a software routine, hardware circuit, firmware, or a combination thereof. Further, elements of an embodiment may be used with other embodiments and/or substituted with elements from another embodiment as would be understood by one of skill in the art.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

What is claimed is:

1. A system for enabling multi-level collaboration in a game development environment comprising:
one or more Authoritative Hierarchy Hosts (AHH) for storing a hierarchy of objects that are used in the game development environment; and
a plurality of clients, in communication with the one or more AHH, for hosting authoring environments for editing the game development environment;
wherein the plurality of clients communicate with the one or more AHH to update the hierarchy of objects during development.

2. The system of claim 1 wherein the one or more AHH comprise:
a network layer for communicate with each of the plurality of clients; and
a data interpretation layer for processing messages from the plurality of clients.

3. The system of claim 1 wherein the one or more AHH maintains the hierarchy of objects to resolve conflicts between the plurality of clients.

4. The system of claim 1 wherein each of the plurality of clients comprises:
a local AHH hierarchy of objects cache for storing a local version of the hierarchy of objects; and
an authoring environment control plugin (AECP) for enabling communication between the client and the one or more AHH.

5. The system of claim 4 wherein each of the plurality of clients comprises:
an authorizing environment for editing the game development environment.

6. A method of enabling multi-level collaboration in a game development environment comprising:
generating a hierarchy of objects associated with the game development environment within an authoritative hierarchy host; and
managing the hierarchy of objects via communications with a plurality of clients, each of the plurality of clients programming in the game development environment.

7. The method of claim 6 wherein managing the hierarchy of objects comprises:
receiving an update from one of the plurality of clients with respect to one of the objects in the hierarchy of objects; and
transmitting a message to each of the other of the plurality of clients to update a local hierarchy of objects with respect to the one of the objects in the hierarchy of objects.

8. The method of claim 6 wherein managing the hierarchy of objects comprises:
resolving conflicts associated with use of objects between the plurality of clients.

9. The method of claim 7 wherein resolving conflicts associated with use of objects is based on an objects lock methodology.

10. The method of claim 7 wherein resolving conflicts associated with use of objects is based on a revisions number methodology.
